(19) United States
(12) Patent Application Publication
(10) Pub. No.: US 2026/0350957 A1
(43) Pub. Date: Nov. 5, 2026

(54) Methods for Determining Regions of Interest for Camera Auto-focus

(71) Applicant: Google LLC, Mountain View, CA (US)

(72) Inventors: Francisco Javier Molina Vela, Encinitas, CA (US); Andrew Patrick Reardon, Sunnyvale, CA (US); Leung Chun Chan, Sunnyvale, CA (US); Ying Chen Lou, Santa Clara, CA (US)

(21) Appl. No.: 19/118,063

(22) PCT Filed: Oct. 4, 2023
(86) PCT No.: PCT/US2023/034441

§ 371 Date: Apr. 3, 2025

Related U.S. Application Data
(60) Provisional application No. 63/378,648, filed on Oct. 6, 2022.

(51) Int. Cl. G06V 10/25; G06T 7/11; G06T 7/194; G06V 10/46; G06V 10/82; H04N 23/63; H04N 23/67

(52) U.S. Cl. CPC G06V 10/25; G06T 7/11; G06T 7/194; G06V 10/464; G06V 10/82; H04N 23/635; H04N 23/675; G06T 2207/10016; G06T 2207/20081; G06T 2207/20084; G06T 2207/20164

(57) ABSTRACT

A method includes receiving an image frame captured by an image capturing device. The method also includes determining a saliency heatmap representing saliency of pixels in the image frame. The method further includes determining, based on the saliency heatmap, a primary region of interest (ROI) and a secondary ROI for the image frame. The method additionally includes determining a filtered ROI for the image frame, where the filtered ROI updates from a previous filtered ROI to the primary ROI or the secondary ROI based on a saliency difference between the previous filtered ROI and the primary ROI or the secondary ROI exceeding a first threshold. The method also includes applying one or more auto-focus processes based on the filtered ROI, the primary ROI, or the secondary ROI.

### CROSS-REFERENCE TO RELATED APPLICATIONS

This application claims priority to U.S. Provisional Patent Application No. 63/378,648, filed Oct. 6, 2022, the disclosure of which is incorporated by reference herein in its entirety.

### BACKGROUND

Many modern computing devices, including mobile phones, personal computers, and tablets, include image capturing devices. Some image capturing devices are configured with telephoto capabilities.

### SUMMARY

In an embodiment, a method includes receiving an image frame captured by an image capturing device. The method also includes determining a saliency heatmap representing saliency of pixels in the image frame. The method further includes determining, based on the saliency heatmap, a primary region of interest (ROI) and a secondary ROI for the image frame. The method additionally includes determining a filtered ROI for the image frame, where the filtered ROI updates from a previous filtered ROI to the primary ROI based on a saliency difference between the previous filtered ROI and the primary ROI exceeding a first threshold. The method also includes applying one or more auto-focus processes based on at least one of the filtered ROI, the primary ROI, or the secondary ROI.

In another embodiment, a system includes a processor and a non-transitory computer-readable medium having stored thereon instructions that, when executed by the processor, cause the processor to perform operations. The operations include receiving an image frame captured by an image capturing device. The operations also include determining a saliency heatmap representing saliency of pixels in the image frame. The operations further include determining, based on the saliency heatmap, a primary region of interest (ROI) and a secondary ROI for the image frame. The operations additionally include determining a filtered ROI for the image frame, where the filtered ROI updates from a previous filtered ROI to the primary ROI based on a saliency difference between the previous filtered ROI and the primary ROI exceeding a first threshold. The operations also include applying one or more auto-focus processes based on at least one of the filtered ROI, the primary ROI, or the secondary ROI.

In an embodiment, an image capturing device includes a camera and a control system. The control system is configured to receive an image frame captured by an image capturing device. The control system is also configured to determine a saliency heatmap representing saliency of pixels in the image frame. The control system is further configured to determine, based on the saliency heatmap, a primary region of interest (ROI) and a secondary ROI for the image frame. The control system is additionally configured to determine a filtered ROI for the image frame, where the filtered ROI updates from a previous filtered ROI to the primary ROI based on a saliency difference between the previous filtered ROI and the primary ROI exceeding a first threshold. The control system is also configured to apply one or more auto-focus processes based on at least one of the filtered ROI, the primary ROI, or the secondary ROI.

In another embodiment, a system is provided that includes means for receiving an image frame captured by an image capturing device. The system also includes means for determining a saliency heatmap representing saliency of pixels in the image frame. The system further includes means for determining, based on the saliency heatmap, a primary region of interest (ROI) and a secondary ROI for the image frame. The system additionally includes means for determining a filtered ROI for the image frame, where the filtered ROI updates from a previous filtered ROI to the primary ROI based on a saliency difference between the previous filtered ROI and the primary ROI exceeding a first threshold. The system also includes means for applying one or more auto-focus processes based on at least one of the filtered ROI, the primary ROI, or the secondary ROI.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates an example computing device, in accordance with example embodiments.

FIG. 2 is a simplified block diagram showing some of the components of an example computing system.

FIG. 3 is a diagram illustrating a training phase and an inference phase of one or more trained machine learning models in accordance with example embodiments.

FIG. 4a is an image, in accordance with example embodiments.

FIG. 4b is a heatmap, in accordance with example embodiments.

FIG. 5 illustrates a heatmap with a bounding box, in accordance with example embodiments.

FIG. 6A illustrates anchor bounding boxes, in accordance with example embodiments.

FIG. 6B illustrates anchor bounding box locations, in accordance with example embodiments.

FIG. 7 illustrates salient regions of interest (ROIs), in accordance with example embodiments.

FIG. 8 illustrates an image with ROIs, in accordance with example embodiments.

FIG. 9 illustrates a finite state machine, in accordance with example embodiments.

FIG. 10 illustrates a finite state machine manager, in accordance with example embodiments.

FIG. 11 is a flowchart of a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For the purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. OVERVIEW

To capture an image using an image capturing device, including digital cameras, smartphones, laptops, and so on, a user can power on the device and initiate an image sensor (e.g., camera) boot-up sequence. A user may initiate the boot-up sequence by selecting an application or simply turning on the device. The boot-up sequence typically involves an iterative optical and software-settings-adjustment process (e.g., automatic focus, automatic exposure, automatic white balance). After the booting sequence is complete, the image capturing device can then capture an image. Ideally, an image capturing device could have the ability to accurately focus and/or apply various auto-focus processes to an image such that that the captured image and/or a preview of the captured image contain a focused view of any objects of interest in the image.

However, determining which areas of an environment to focus on (e.g., which areas of an environment contain objects of interest) may be complicated by various objects in the environment, many of which may be a potential area to focus. In addition, an object that the image capturing device is focusing on may move or be moved to a different location and/or out of the frame of the image capturing device. It may therefore be important that the image capturing device is able to quickly switch to another region to focus on. Further, with various objects in the environment, the image capturing device may associate various areas with similar interest levels, and the image capturing device may fluctuate between focusing on one area to focusing on another area with a similar interest level.

Described herein are techniques for image capturing devices to automatically focus on areas of an image frame that are associated with high saliency while reducing instability and areas incorrectly determined to be salient. In some examples, through utilization of a machine-learned technique, the image capturing device may detect a visual saliency region within an image frame, generate one or more bounding boxes enclosing one or more visual saliency regions, determine which visual saliency region to focus on, and apply one or more autofill processes to that visual saliency region in the image frame.

In some examples, the image capturing device may determine a primary region of interest (ROI) and a more stable filtered ROI based on the primary ROI. For each image frame, the image capturing device may initially set the filtered ROI to be the same as the previous filtered ROI and may update a filtered ROI confidence value to be the average of saliency values at the pixels of an updated heatmap. Based on the amount of overlap and/or the relative confidences of the primary ROI and the previous filtered ROI, the image capturing device may determine whether to match the filtered ROI to the primary ROI or to cause the filtered ROI to remain the same as the previous filtered ROI. In some examples, the image capturing device may determine whether the amount of overlap between the primary ROI and the previous filtered ROI does not exceed a threshold, and based on that determination, the image capturing device may update the filtered ROI to the primary ROI. If the image capturing device determines that the amount of overlap does exceed a threshold, the image capturing device may maintain the filtered ROI. In that case, the image capturing device may set the filtered ROI to be the same as the previous filtered ROI and may update a filtered ROI confidence value to be the average of the saliency values at the pixels of an updated heatmap. Additionally and/or alternatively, the computing system may determine a saliency difference between the previous filtered ROI and the primary ROI, and based on the saliency difference exceeding a threshold, the computing system may update the previous filtered ROI to the primary ROI. If the computing system determines that the saliency difference does not exceed a threshold, the computing system may maintain the filtered ROI as the previous ROI.

Updating the filtered ROI based on the primary ROI and the previous filtered ROI may result in the filtered ROI being updated to the primary ROI when the previous filtered ROI is no longer salient, as the filtered ROI may remain as the previous filtered ROI with an updated confidence value based on the updated heatmap until the region is no longer salient. Allowing the filtered ROI to remain as the previous filtered ROI may facilitate stability when the image frame changes slightly from frame to frame as well as when the frame has multiple objects of similar saliency.

In further examples, the image capturing device may determine both a primary region of interest (ROI) and a secondary ROI. The secondary ROI may be determined such that the secondary ROI does not overlap the primary ROI or a banned region around the primary ROI. Because the computing device uses at least two ROIs for the current image frame to determine where to focus, the computing device may consider two salient objects and/or regions simultaneously, thereby potentially making switching from focusing on one region to another region faster and more seamless. In addition, the computing device may apply a low pass filter to the primary ROI, perhaps by applying a threshold to a saliency difference and/or an amount of overlap before switching the filtered ROI to the primary ROI, thereby potentially making the filtered ROI more stable and power efficient.

In further examples, the computing device may select between the filtered ROI, the primary ROI, and the secondary ROI to determine an area in the image frame to focus on with one or more auto-focus processes. In order to address the potential issue that saliency detection may show instability in time, a Finite State Machine (FSM) may be used. This FSM may require several consecutive frames with consistent saliency detections for auto-focus to commit to a salient ROI and/or requires several consecutive frames with lack of consistent saliency detections for auto-focus to abandon the salient ROI. In this context, consistent detections refer to overlapping of detected bounding boxes between consecutive frames and/or high confidence in these detections.

An additional potential challenge is that saliency detection often reports salient regions that are not. This is known as a false positive, and this kind of error may be particularly damaging for the user experience with the camera. Imagine the camera trying to focus, for example, on a shiny object in the background of the scene. To address this challenge, the FSM helps because it takes care of instantaneous false positives: the FSM is less likely to detect consecutive false positives rather than a false positive in a single frame. In addition to this, in order to prevent false positives, the application of saliency auto-focus processes may be restricted based on global on-device signals. For example, certain requirements may be imposed (e.g., a minimum brightness value in the scene, a zoom ratio within a certain range, and/or lack of device motion) before allowing auto-focus. In addition, certain salient regions may be discarded when the estimated depth is out of range, when the estimated depth is too different from the estimated distance of a current ROI, and/or when the location of the bounding box is too far off-center.

### II. EXAMPLE SYSTEMS AND METHODS

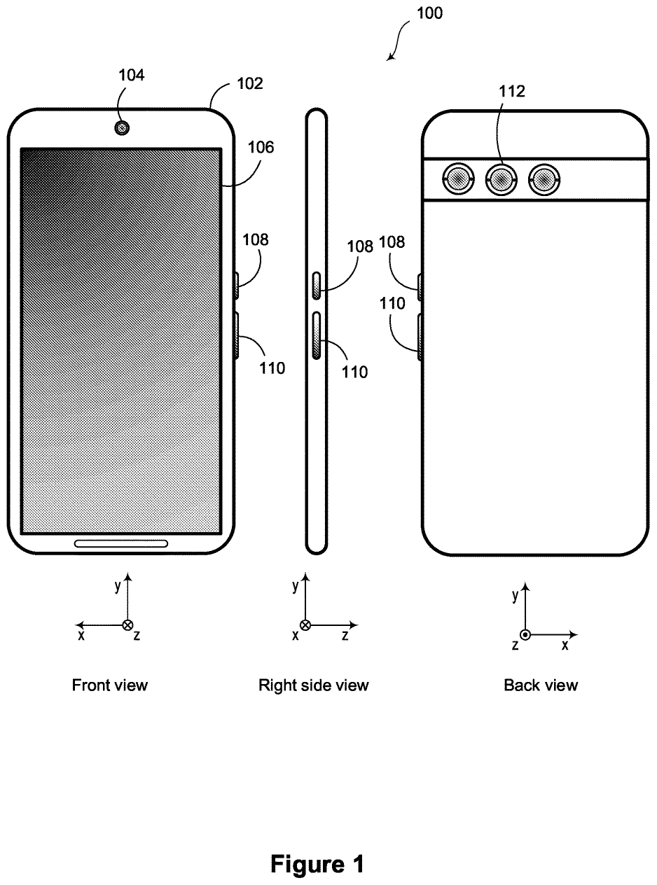

FIG. 1 illustrates an example computing device 100. Computing device 100 is shown in the form factor of a mobile phone. However, computing device 100 may be alternatively implemented as a laptop computer, a tablet computer, and/or a wearable computing device, among other possibilities. Computing device 100 may include various elements, such as body 102, display 106, and buttons 108 and 110. Computing device 100 may further include one or more cameras, such as front-facing camera 104 and one or more rear-facing cameras 112. Each of the rear-facing cameras may have a different field of view. For example, the rear facing cameras may include a wide angle camera, a main camera, and a telephoto camera. The wide angle camera may capture a larger portion of the environment compared to the main camera and the telephoto camera, and the telephoto camera may capture more detailed images of a smaller portion of the environment compared to the main camera and the wide angle camera.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a viewfinder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

One or more of front-facing camera 104 and/or rear-facing camera 112 may include or be associated with an illumination component that provides a light field to illuminate a target object. For instance, an illumination component could provide flash or constant illumination of the target object. An illumination component could also be configured to provide a light field that includes one or more of structured light, polarized light, and light with specific spectral content. Other types of light fields known and used to recover three-dimensional (3D) models from an object are possible within the context of the examples herein.

Computing device 100 may also include an ambient light sensor that may continuously or from time to time determine the ambient brightness of a scene that cameras 104 and/or 112 can capture. In some implementations, the ambient light sensor can be used to adjust the display brightness of display 106. Additionally, the ambient light sensor may be used to determine an exposure length of one or more of cameras 104 or 112, or to help in this determination.

Computing device 100 could be configured to use display 106 and front-facing camera 104 and/or rear-facing camera 112 to capture images of a target object. The captured images could be a plurality of still images or a video stream. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing device 100 a predetermined distance, or according to a predetermined capture schedule.

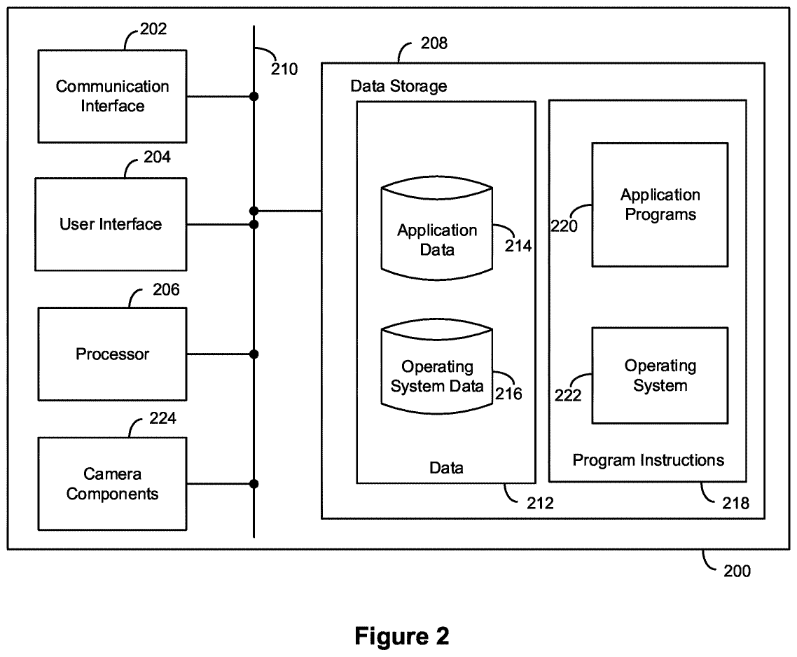

FIG. 2 is a simplified block diagram showing some of the components of an example computing system 200. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 2, computing system 200 may include communication interface 202, user interface 204, processor 206, data storage 208, and camera components 224, all of which may be communicatively linked together by a system bus, network, or other connection mechanism 210. Computing system 200 may be equipped with at least some image capture and/or image processing capabilities. It should be understood that computing system 200 may represent a physical image processing system, a particular physical hardware platform on which an image sensing and/or processing application operates in software, or other combinations of hardware and software that are configured to carry out image capture and/or processing functions.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors—e.g., microprocessors—and/or one or more special purpose processors—e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

Camera components 224 may include, but are not limited to, an aperture, shutter, recording surface (e.g., photographic film and/or an image sensor), lens, shutter button, infrared projectors, and/or visible-light projectors. Camera components 224 may include components configured for capturing of images in the visible-light spectrum (e.g., electromagnetic radiation having a wavelength of 380-700 nanometers) and/or components configured for capturing of images in the infrared light spectrum (e.g., electromagnetic radiation having a wavelength of 701 nanometers-1 millimeter), among other possibilities. Camera components 224 may be controlled at least in part by software executed by processor 206.

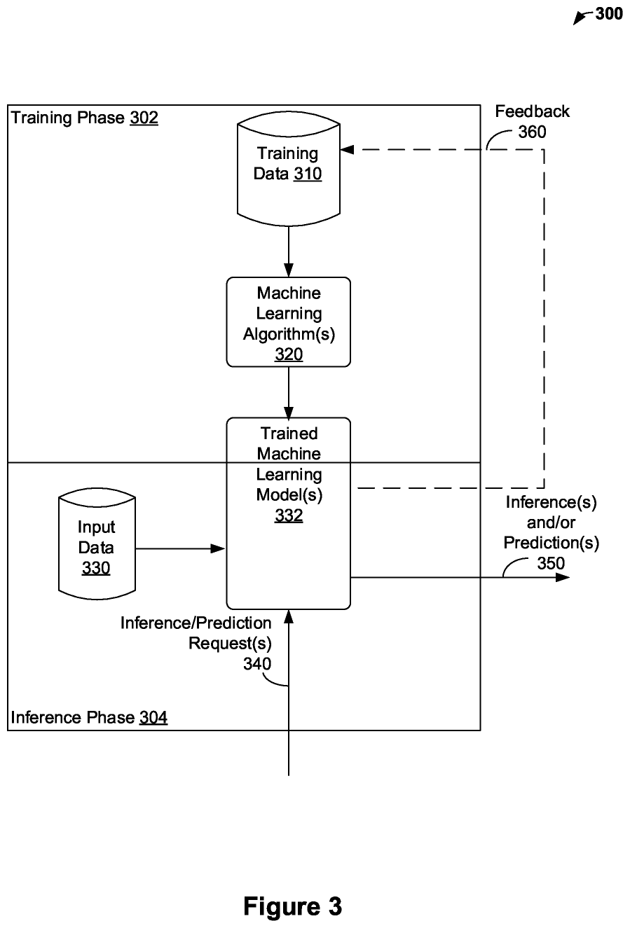

FIG. 3 shows diagram 300 illustrating a training phase 302 and an inference phase 304 of trained machine learning model(s) 332, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 3 shows training phase 302 where one or more machine learning algorithms 320 are being trained on training data 310 to become trained machine learning model 332. Producing trained machine learning model(s) 332 during training phase 302 may involve determining one or more hyperparameters, such as one or more stride values for one or more layers of a machine learning model as described herein. Then, during inference phase 304, trained machine learning model 332 can receive input data 330 and one or more inference/prediction requests 340 (perhaps as part of input data 330) and responsively provide as an output one or more inferences and/or predictions 350. The one or more inferences and/or predictions 350 may be based in part on one or more learned hyperparameters, such as one or more learned stride values for one or more layers of a machine learning model as described herein

As such, trained machine learning model(s) 332 can include one or more models of one or more machine learning algorithms 320. Machine learning algorithm(s) 320 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 120 may be supervised or unsupervised, and may implement any suitable combination of online and offline learning.

In some examples, machine learning algorithm(s) 320 and/or trained machine learning model(s) 332 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 320 and/or trained machine learning model(s) 332. In some examples, trained machine learning model(s) 332 can be trained, reside and execute to provide inferences on a particular computing device, and/or otherwise can make inferences for the particular computing device.

During training phase 302, machine learning algorithm(s) 320 can be trained by providing at least training data 310 as training input using unsupervised, supervised, semi-supervised, and/or reinforcement learning techniques. Unsupervised learning involves providing a portion (or all) of training data 310 to machine learning algorithm(s) 320 and machine learning algorithm(s) 320 determining one or more output inferences based on the provided portion (or all) of training data 310. Supervised learning involves providing a portion of training data 310 to machine learning algorithm(s) 320, with machine learning algorithm(s) 320 determining one or more output inferences based on the provided portion of training data 310, and the output inference(s) are either accepted or corrected based on correct results associated with training data 310. In some examples, supervised learning of machine learning algorithm(s) 320 can be governed by a set of rules and/or a set of labels for the training input, and the set of rules and/or set of labels may be used to correct inferences of machine learning algorithm(s) 320.

Semi-supervised learning involves having correct results for part, but not all, of training data 310. During semi-supervised learning, supervised learning is used for a portion of training data 310 having correct results, and unsupervised learning is used for a portion of training data 310 not having correct results.

Reinforcement learning involves machine learning algorithm(s) 320 receiving a reward signal regarding a prior inference, where the reward signal can be a numerical value. During reinforcement learning, machine learning algorithm(s) 320 can output an inference and receive a reward signal in response, where machine learning algorithm(s) 320 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 320 and/or trained machine learning model(s) 332 can be trained using other machine learning techniques, including but not limited to, incremental learning and curriculum learning.

In some examples, machine learning algorithm(s) 320 and/or trained machine learning model(s) 332 can use transfer learning techniques. For example, transfer learning techniques can involve trained machine learning model(s) 332 being pre-trained on one set of data and additionally trained using training data 310. More particularly, machine learning algorithm(s) 320 can be pre-trained on data from one or more computing devices and a resulting trained machine learning model provided to computing device CD1, where CD1 is intended to execute the trained machine learning model during inference phase 304. Then, during training phase 302, the pre-trained machine learning model can be additionally trained using training data 310. This further training of the machine learning algorithm(s) 320 and/or the pre-trained machine learning model using training data 310 of CD1's data can be performed using either supervised or unsupervised learning. Once machine learning algorithm(s) 320 and/or the pre-trained machine learning model has been trained on at least training data 310, training phase 302 can be completed. The trained resulting machine learning model can be utilized as at least one of trained machine learning model(s) 332.

In particular, once training phase 302 has been completed, trained machine learning model(s) 332 can be provided to a computing device, if not already on the computing device. Inference phase 304 can begin after trained machine learning model(s) 332 are provided to computing device CD1.

During inference phase 304, trained machine learning model(s) 332 can receive input data 330 and generate and output one or more corresponding inferences and/or predictions 350 about input data 330. As such, input data 330 can be used as an input to trained machine learning model(s) 332 for providing corresponding inference(s) and/or prediction(s) 350. For example, trained machine learning model(s) 332 can generate inference(s) and/or prediction(s) 350 in response to one or more inference/prediction requests 340. In some examples, trained machine learning model(s) 332 can be executed by a portion of other software. For example, trained machine learning model(s) 332 can be executed by an inference or prediction daemon to be readily available to provide inferences and/or predictions upon request. Input data 330 can include data from computing device CD1 executing trained machine learning model(s) 332 and/or input data from one or more computing devices other than CD1.

An example image capturing device described herein may include one or more cameras and sensors, among other components. The image capturing device may be a smartphone, tablet, laptop, or digital camera, among other types of computing devices that may carry out the operations described herein.

As an example, a computing device may include one or more processors having logic for executing instructions, at least one built-in or peripheral image sensor (e.g., a camera), and an input/output device for displaying a user interface (e.g., a display panel). The computing device may further include a computer-readable medium (CRM). The CRM may include any suitable memory or storage device like random-access memory (RAM), static RAM (SRAM), dynamic RAM (DRAM), non-volatile RAM (NVRAM), read-only memory (ROM), or flash memory. The computing device stores device data (e.g., user data, multimedia data, applications, and/or an operating system of the device) on the CRM. The device data may include executable instructions for automatic zoom processes. The automatic zoom processes may be part of an operating system executing on the image capturing device, or may be a separate component executing within an application environment (e.g., a camera application) or a “framework” provided by the operating system.

The computing device may implement a machine-learned technique (“Visual Saliency Model”). The Visual Saliency Model may be implemented as one or more of a support vector machine (SVM), a recurrent neural network (RNN), a convolutional neural network (CNN), a dense neural network (DNN), one or more heuristics, other machine-learning techniques, a combination thereof, and so forth. The Visual Saliency Model may be iteratively trained, off-device, by exposure to training scenes, sequences, and/or events. For example, training may involve exposing the Visual Saliency Model to images (e.g., digital photographs), including user-drawn bounding boxes containing a visual saliency region (e.g., a region wherein one or more objects of particular interest to a user may reside). In some examples, these images may include bounding boxes or a heatmap generated by tracking an annotator's eyes while the annotator is looking at an image to determine which areas of the image are most salient. Further, in some examples, the Visual Saliency Model may be trained with heatmaps, perhaps generated from tracking locations of the image at which the annotators look. For example, if five annotators look at a first area and ten look at a second area, then the first area in the image may be determined to be half as salient as the second area in the image. Exposure to images including user-drawn bounding boxes may facilitate training of the Visual Saliency Model to identify visual saliency regions within images. As a result of the training, the Visual Saliency Model can generate a visual saliency heatmap for a given image. A computing device may then generate various bounding boxes, including a bounding box that encloses the region with the greatest visual saliency score, based on the visual saliency heatmap. In this way, the Visual Saliency Model can predict visual saliency regions within images. After sufficient training, model compression using distillation can be implemented on the Visual Saliency Model enabling the selection of an optimal model architecture based on model latency and power consumption. The Visual Saliency Model can then be deployed to the CRM of the computing device as an independent module or implemented into the automatic zoom processes.

The computing device may carry out automatic zoom processes, perhaps automatically or in response to a received triggering signal, including, for example, a user performed gesture (e.g., tapping, pressing) enacted on the input/output device. The computing device may receive one or more captured images from the image sensor.

The computing device may utilize the Visual Saliency Model to generate a visual saliency heatmap using the one or more captured images.

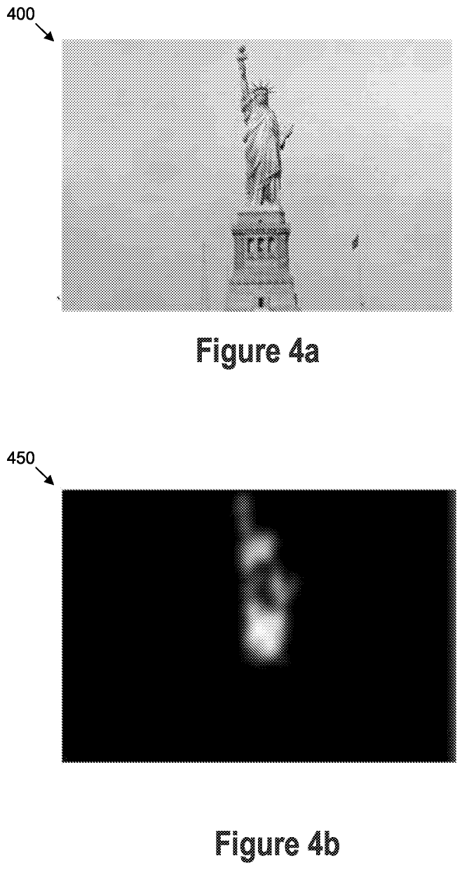

For example, FIG. 4a is an image 400, in accordance with example embodiments. FIG. 4b is a heatmap 450, in accordance with example embodiments. The computing device may utilize the Visual Saliency Model to generate a visual saliency heatmap of the captured image, as illustrated in FIGS. 4a and 4b. One or more processors may calculate the visual saliency heatmap in the background operations of the device. In some examples, the image capturing device may not display the visual saliency heatmap to the user. As illustrated, the visual saliency heatmap depicts the magnitude of the visual saliency probability on a scale from black to white, where white indicates a high probability of saliency and black indicates a low probability of saliency. Each pixel within the visual saliency heatmap may be assigned a saliency metric that represents how salient the region represented by the metric is based on a computing device applying a pre-trained machine learning model to the image frame, such that the pre-trained machine learning model outputs a saliency metric for each pixel within the visual saliency heatmap.

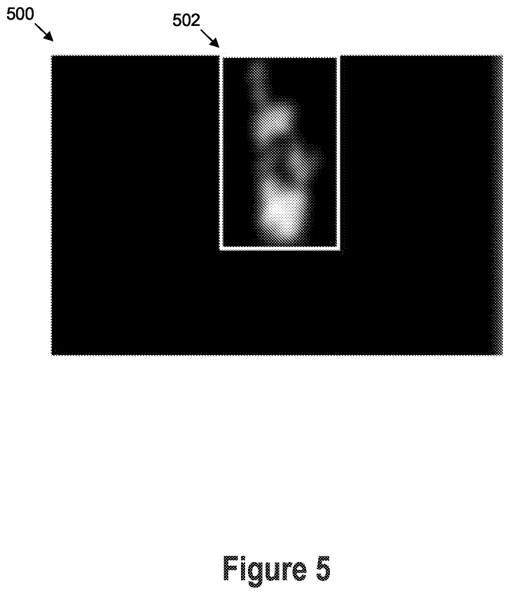

The Visual Saliency Model may produce a bounding box enclosing the region with the greatest probability of visual saliency. FIG. 5 illustrates a heatmap 500 with a bounding box 502, in accordance with example embodiments.

As illustrated in FIG. 5, the visual saliency heatmap includes bounding box 502 enclosing the region within the image containing the greatest probability of visual saliency. The Visual Saliency Model can be trained to output a heatmap, which the computing device can use to determine one or more objects of interest in a captured image and to generate one or more bounding boxes around those objects of interest. These generated bounding boxes may include one or more regions that the computing device predicted to be salient.

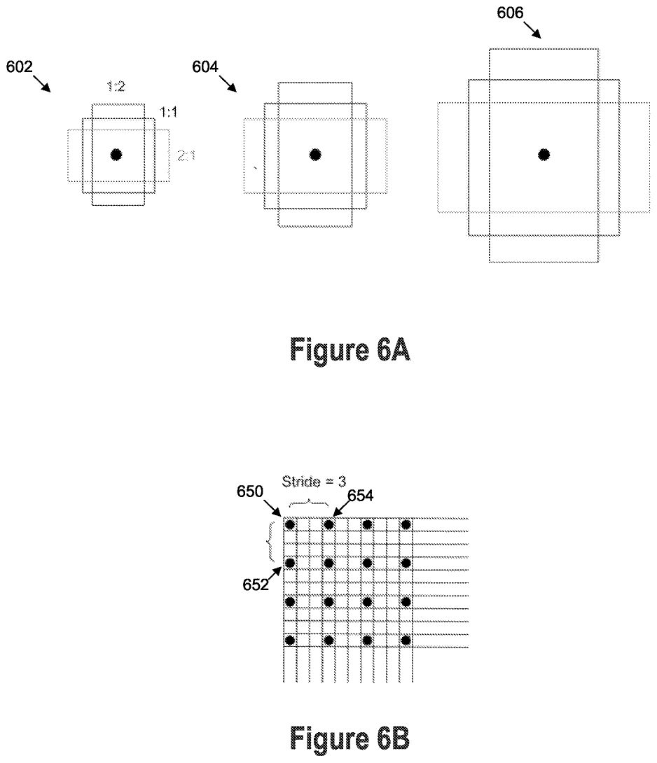

In some examples, a computing device may experiment with anchor boxes of various sizes and various locations, such as described in Faster R-CNN by Ren et al., 2016. In particular, as described herein, anchor boxes may be considered in order to determine a region of interest, e.g., an area with a high or the highest average saliency value. For example, FIG. 6A illustrates anchor bounding box sizes 602, 604, and 606, in accordance with example embodiments. As FIG. 6A illustrates, the computing device may assess anchor bounding boxes of different aspect ratios (e.g., 1:2, 1:1, and 2:1), and the computing device may assess anchor bounding boxes of various sizes for each of the different aspect ratios. The computing device may determine the average saliency value for an anchor bounding box of each aspect ratio and size for various anchor bounding box locations. In particular, each pixel in the heat map may be associated with a saliency value, and the computing device may determine the average of the saliency values of the pixels within the anchor bounding box to determine the average saliency value.

FIG. 6B illustrates anchor bounding box locations, in accordance with example embodiments. As FIG. 6B illustrates, the computing device may assess average saliency values of anchor bounding boxes of various sizes and aspect ratios every few pixels. The center of the anchor bounding boxes may be evenly spaced based on a stride value, and at each location, the computing device may assess various sizes and aspect ratios of the anchor bounding boxes. For example, a computing device may determine the average saliency values of anchor bounding boxes of the nine anchor bounding box sizes 602, 604, and 606 with aspect ratios of 1:2, 1:1, and 2:1 at location 650, location 652, location 654, among other locations that are separated by a stride of three pixels. Based on the average saliency values of the anchor bounding boxes, the computing device may determine one or more regions of interest (ROIs).

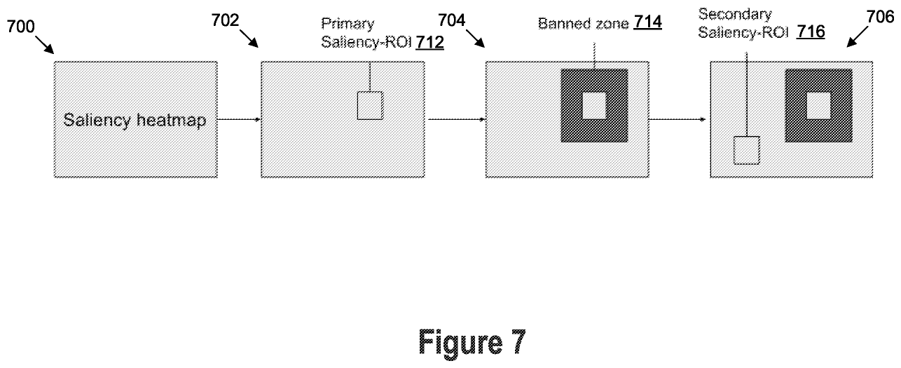

FIG. 7 illustrates salient ROIs, in accordance with example embodiments. In an example process, the computing device may determine saliency heatmap 700 according to the processes described above, perhaps through use of a machine-learning model or other algorithm that predicts a saliency metric at each pixel of an image frame. Based on saliency heatmap 700, the computing device may determine a primary ROI with maximum average saliency, perhaps through calculating average saliency values for pixels within a variety of anchor bounding boxes, as described above in the context of FIGS. 6A-6B.

Next, based on the primary ROI, the computing device may determine a secondary ROI, which may be an ROI with pixels of a lesser average saliency value when compared with the primary ROI. The secondary ROI may be required to be at least a threshold distance away from the primary ROI. As illustrated by image 704, the computing device may determine the secondary ROI based on banned zone 714. Banned zone 714 may be an area around primary ROI 712 in which the secondary ROI cannot be located. The computing device may determine secondary ROI 716 such that secondary ROI 716 does not overlap with primary ROI 712 or banned zone 714. In some examples, the computing device may apply the anchor bounding box method described above to the pixels outside primary ROI 712 and banned zone 714 to determine secondary ROI 716. In particular, the primary ROI 712 may be the region with the greatest average saliency and the secondary ROI 716 may be the region with the second greatest average saliency, subject to the constraint described above.

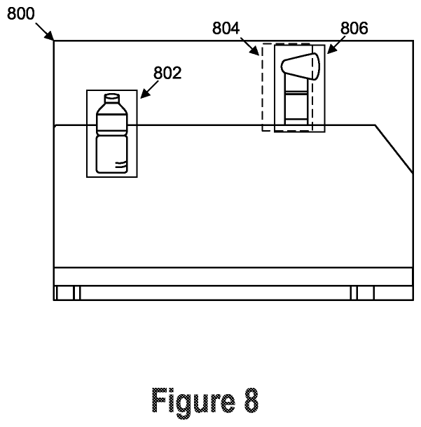

Based on primary ROI 712 and the secondary ROI 716, the computing system may then determine a more stable filtered ROI, which may then potentially be used for one or more auto-focus processes. For example, FIG. 8 illustrates image 800 with ROIs 802, 804, and 806, in accordance with example embodiments. Image 800 may include primary ROI 806, secondary ROI 802, and previous filtered ROI 804.

Primary ROI 806 may include an area in the image frame that is most salient, which the computing device may determine using the anchor bounding box method described above. Secondary ROI 802 may include an area in the image frame that is less salient than primary ROI 806. Previous filtered ROI 804 may be of an area in a previous image frame that the computing device previously determined based on a previous primary ROI.

Based on primary ROI 806 and previous filtered ROI 804, the computing device may determine a new filtered ROI of an area in the image frame. The filtered ROI may then potentially be used to apply one or more auto-focus processes. For example, the computing device may determine a confidence value for previous filtered ROI 804 and a confidence value for primary ROI 806. In particular, the computing device may determine a confidence value for the previous filtered ROI 804 based on an average saliency value in the previous filtered ROI when computed from the saliency heatmap of the image frame, despite previous filtered ROI 804 being associated with a previous image frame. The confidence value of the primary ROI may similarly bey be based on an average saliency value in the respective ROI when computed from the saliency heatmap generated from the image frame. The computing device may determine that the saliency difference between previous filtered ROI 804 and primary ROI 806 exceeds a threshold value (e.g., that the confidence value for the primary ROI 806 exceeds the confidence value for the previous filtered ROI 804 by the threshold value). Based on this determination, the computing device may update the filtered ROI from the previous filtered ROI 804 to the primary ROI 806. Additionally and/or alternatively, if the computing device determines that the saliency difference between previous filtered ROI 804 and primary ROI 906 does not exceed a threshold value, then the computing device may maintain the previous filtered ROI.

In some alternative examples, the computing device may also consider the secondary ROI 802 and determine that the saliency difference between previous filtered ROI 804 and secondary ROI 802 exceeds the threshold value (e.g., that the confidence value for the secondary ROI 802 exceeds the confidence value for the previous filtered ROI 804 by the threshold value), and the computing device may update the filtered ROI from previous filtered ROI 804 to secondary ROI 802. Other considerations, such as the stability of the primary ROI, the secondary ROI, and/or the previous filtered ROI may also be taken into account.

In some examples, the computing device may determine a filtered ROI based on an amount of overlap that either primary ROI 806 and/or secondary ROI 802 has with previous filtered ROI 804. In particular, the computing system may determine a first amount of overlap of the previous filtered ROI 806 to the primary ROI 804 and a second amount of overlap of the secondary ROI 802 with the previous filtered ROI 806. If the first amount of overlap and the second amount of overlap both do not exceed a threshold, then the computing device may update the filtered ROI to either be primary ROI 804 or secondary ROI 802 based on which ROI is associated with a greater average saliency value. A lesser overlap (e.g., an overlap that does not exceed the threshold) may indicate that updating the filtered ROI may have a greater impact, whereas a greater overlap (e.g. an overlap that exceeds the threshold) may indicate that updating the filtered ROI may have negligible impact. Updating the filtered ROI to another location when the filtered ROI has a high overlap with the other location may result in poor user experience, as the area that is in focus may rapidly change with time. In further examples, both saliency difference and amount of overlap may be considered in determining whether to update the filtered ROI.

In some examples, the computing system may determine whether the filtered ROI updates from the primary ROI to the secondary ROI based on whether the previous filtered ROI overlaps with the primary ROI or with the secondary ROI. For example, the computing device may update the filtered ROI to the secondary ROI when the saliency difference between the primary ROI and the secondary ROI does not exceed a threshold and when the secondary ROI overlaps with the previous ROI or overlaps by at least a threshold amount. Otherwise, the computing device may determine to update the filtered ROI to the primary ROI when the saliency difference between the primary ROI and the secondary ROI exceeds a threshold value.

After having determined a filtered ROI, the computing device may apply one or more auto-focus processes to the image frame. In some examples, applying the one or more auto-focus processes may involve causing a camera lens to adjust so that the lens is focused on the filtered ROI. In further examples, the computing device may apply a blur to a region of the image frame outside of the filtered ROI, perhaps as a way of artificially blurring the background of the image frame, and causing the focus of the image frame to become the region within the filtered ROI.

As mentioned above, in some examples, saliency detection may be unstable over time and may report salient regions that are not actually salient. For example, the computing system may alternate between two regions that are roughly equivalent in saliency, which may make an image frame periodically and/or randomly out of focus. Out of focus image frames may make it difficult to run additional algorithms (e.g., classifiers to detect objects in the image, perhaps to make the images more readily searchable) and make for a poorer user experience.

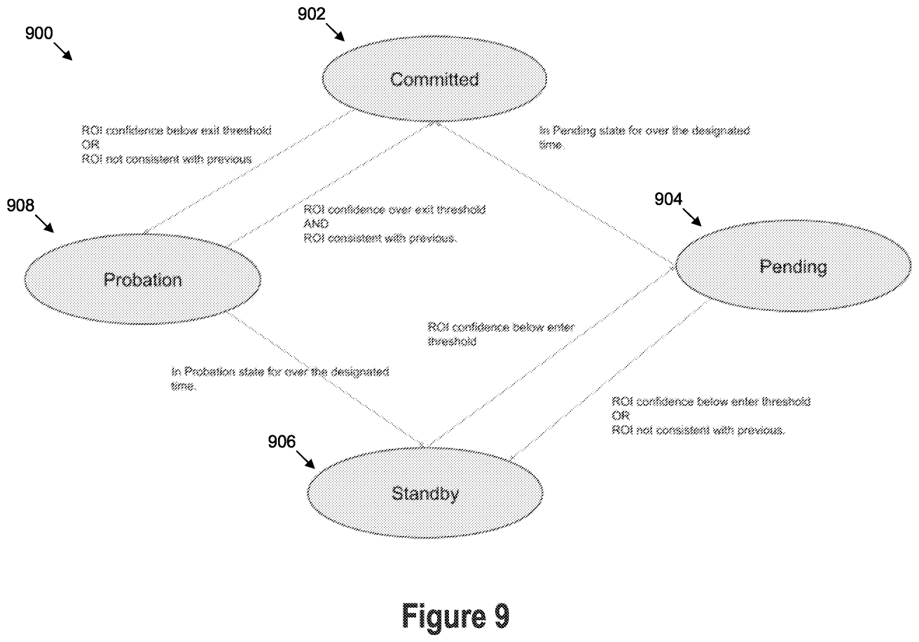

To facilitate determination of focused image frames, the computing device may determine whether to apply one or more auto-focus processes based on the filtered ROI being associated with a particular state of a finite state machine. FIG. 9 illustrates finite state machine 900, in accordance with example embodiments. Finite state machine 900 may help facilitate avoiding instantaneous false positives.

As shown in FIG. 9, finite state machine 900 includes committed state 902, pending state 904, standby state 906, and probation state 908. Committed state 902 may indicate that the filtered ROI is usable, pending state 904 may indicate that filtered ROI is waiting for stability verification, probation state 908 may indicate that the filtered ROI is usable but waiting for failure of stability verification, and standby state 906 may indicate that the filtered ROI is not usable. In standby state 906, the computing device may elect to not proceed with applying one or more auto-focus processes based on the ROI, whereas in committed state 902 or probation state 908, the computing device may elect to proceed with applying the one or more auto-focus processes. In pending state 904, the computing device may elect to not proceed with applying the one or more auto-focus process, perhaps until the ROI has been verified to be stable or not stable.

For an image frame including a primary ROI, a secondary ROI, and a filtered ROI, the computing device may assign a state to each of the ROIs, which may be updated each time a new primary, secondary, and/or filtered ROI is determined. For example, if the primary ROI, the secondary ROI, or the filtered ROI are each associated with a confidence measure (e.g., an average saliency value) that does not exceed a threshold value, then the computing device may update the respective ROI state from pending state 904 to standby state 906, committed state 902 to probation state 908, and/or probation state 908 to standby state 906.

Further, if the primary ROI, the secondary ROI, or the filtered ROI are not consistent with and/or do not match with any of the previous primary ROI, the previous secondary ROI, and/or the previous filtered ROI, then the computing device may update the state of the respective ROI to be from pending state 904 to standby state 906, from committed state 902 to probation state 908, and/or from probation state 908 to standby state 906. In some examples, consistency for a primary ROI (or a secondary ROI or a filtered ROI) may be defined as having a threshold amount of overlap with the previous primary ROI and not having too abrupt of a change in depth.

In addition, if the confidence value (e.g., a determined average saliency value for the pixels within the ROI) is above a threshold value and the consistency is also adequate (e.g., the amount of overlap is above a threshold value, perhaps among other factors), then the computing device may update the state of the respective ROI from pending state 904 to committed state 902 or from probation state 908 to committed state 902.

In some examples, the filtered ROI, the primary ROI, and the secondary ROI may act as an object detector, with each of the ROIs indicating one or more objects. However, the filtered ROI, the primary ROI and/or the secondary ROI may not necessarily detect objects, but rather, locations in an image frame that are most salient. For example, the filtered ROI, the primary ROI, and/or the secondary ROI may also track an off center object next to a textured wall or a group of people in the background, as long as these subjects are the most salient. Therefore, a computing system executing the methods described herein may output an off-center focused area on top of a textured wall or a group of people in the background, such that the focused area is moving but not necessarily following an object.

In addition, a computing system executing the methods described herein may be able to switch quickly from focusing on one area indicated by an ROI to another area indicated by another ROI, because the computing system identifies multiple ROIs. Therefore, if an object located at the filtered ROI is no longer present and the filtered ROI is no longer very salient, then the computing system may quickly switch to focusing on the primary ROI or the secondary ROI. Further, if the image frame contains two objects of similar saliency in the primary ROI and the secondary ROI, a computing device executing the method described herein may maintain stability for a certain amount of image frames on the primary ROI, before perhaps switching to the secondary ROI, rather than continuously switching between the primary and secondary ROI.

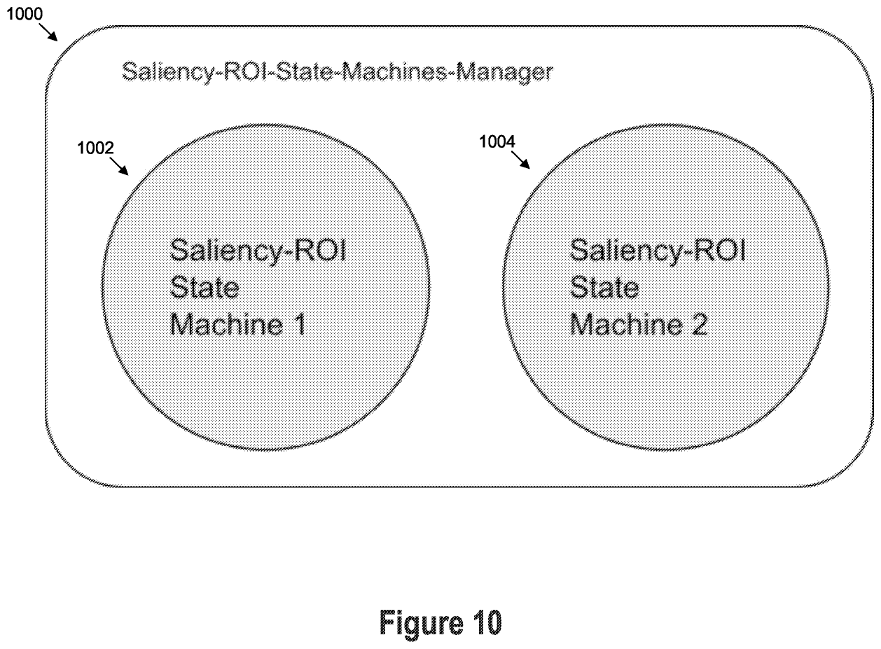

FIG. 10 illustrates finite state machine manager 1000, in accordance with example embodiments. Finite state manager 1000 includes saliency ROI state machine 1002 and saliency ROI state machine 1004. Finite state manager 1000 may prepare a candidate ROI (e.g., the primary ROI, secondary ROI, previous filtered ROI, or filtered ROI) to be input into either saliency ROI state machine 10002 or saliency ROI state machine 1004 by verifying a few factors. For example, if a candidate ROI is already associated with a saliency ROI state machine, the candidate ROI may not be input into the other saliency ROI state machine. If an object inside a candidate ROI is not within a valid distance range, then the candidate ROI may be discarded. And if the candidate ROI is not within a valid window close to the center of the image, then the candidate ROI may also be discarded.

Having two saliency ROI state machines may help facilitate switching between applying one or more auto-focus algorithms to one area of an image frame to another area of the image frame. For example, if an object that is in focus in the image frame disappears in a short timeframe, and the object was associated with saliency ROI state machine 1002, then the computing device may check if the state of the candidate ROI region associated with saliency ROI state machine 1004 is an acceptable state. If the state is acceptable, then the computing device may quickly switch to focusing on the candidate ROI.

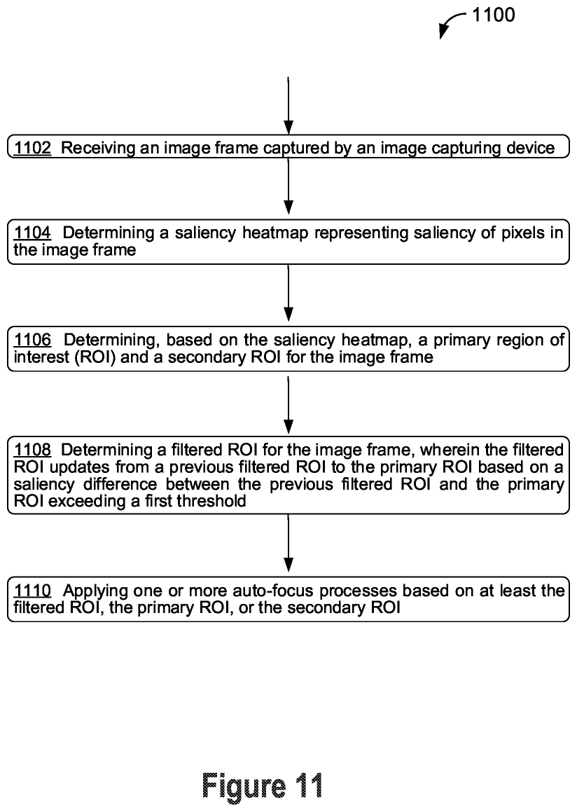

FIG. 11 is a flow chart of method 1100, in accordance with example embodiments. Method 1100 may be executed by one or more computing systems (e.g., computing system 200 of FIG. 2) and/or one or more processors (e.g., processor 206 of FIG. 2). Method 1300 may be carried out on a computing device, such as computing device 100 of FIG. 1.

At block 1102, method 1100 includes receiving an image frame captured by an image capturing device.

At block 1104, method 1100 includes determining a saliency heatmap representing saliency of pixels in the image frame.

At block 1106, method 1100 includes determining, based on the saliency heatmap, a primary ROI and a secondary ROI for the image frame.

At block 1108, method 1100 includes determining a filtered ROI for the image frame. The filtered ROI updates from a previous filtered ROI to the primary ROI based on a saliency difference between the previous filtered ROI and the primary ROI exceeding a first threshold.

At block 1110, method 1100 includes applying one or more auto-focus processes based on at least one of the filtered ROI, the primary ROI, or the secondary ROI.

In some examples, determining the primary ROI and the secondary ROI is based on the primary ROI having a greater average saliency than the secondary ROI.

In some examples, the filtered ROI updates from the previous filtered ROI to the primary ROI further based on a first amount of overlap of the previous filtered ROI to the primary ROI and a second amount of overlap of the previous filtered ROI both not exceeding a second threshold.

In some examples, when the filtered ROI is set to the previous filtered ROI, the filtered ROI is associated with an updated average saliency value based on the saliency heatmap.

In some examples, determining, based on the saliency heatmap, the primary ROI and the secondary ROI comprises determining a plurality of candidate anchor boxes distributed over the saliency heatmap, where each of the candidate anchor boxes is associated with a saliency measure, where determining the primary ROI and the secondary ROI is based on the saliency measure of each of the candidate anchor boxes.

In some examples, the plurality of candidate anchor boxes comprises a plurality of anchor boxes with a plurality of differing aspect ratios at a given location in the image frame.

In some examples, the candidate anchor boxes are evenly distributed over the saliency heatmap.

In some examples, the plurality of candidate anchor boxes comprises a plurality of anchor boxes with a plurality of sizes at a given location in the image frame.

In some examples, the primary ROI is associated with a primary confidence measurement and the previous filtered ROI is associated with a filtered confidence measurement based on the saliency heatmap, where the saliency difference is based on the primary confidence measurement and the filtered confidence measurement.

In some examples, the primary confidence measurement is based on an average of one or more saliency values at one or more pixels within the primary ROI and the filtered confidence measurement is based on an average of one or more saliency values at one or more pixels within the previous filtered ROI.

In some examples, determining the primary ROI and the secondary ROI is based on the primary ROI being at least a threshold distance away from the secondary ROI.

In some examples, determining the primary ROI and the secondary ROI comprises determining a primary ROI based on the saliency heatmap, determining a banned region around the primary ROI, based on the banned region around the primary ROI and the saliency heatmap, determining the secondary ROI such that the secondary ROI is not within the primary ROI or the banned region around the primary ROI.

In some examples, the previous filtered ROI is based on a previous image frame captured prior to the image frame.

In some examples, determining a saliency heatmap representing saliency of each pixel in the image frame comprises applying a pre-trained machine learning model to the image frame to determine the saliency heatmap.

In some examples, applying the one or more auto-focus processes comprises causing a camera lens to adjust focus to the filtered ROI.

In some examples, applying the one or more auto-focus process comprises applying a blur to a region of the image frame outside of the filtered ROI.

In some examples, method 1100 further comprises applying a finite state machine to the filtered ROI, where applying the one or more auto-focus processes is based on the filtered ROI being associated with a particular state of the finite state machine.

In some examples, the finite state machine comprises a committed state indicating that the filtered ROI is usable, a pending state indicating that the filtered ROI is waiting for stability verification, a probation state indicating that the filtered ROI is usable but waiting for failure of stability verification, and a standby state indicating that the filtered ROI is not usable.

In some examples, method 1100 further comprises updating a state associated with the filtered ROI, where updating the state associated with the filtered ROI comprises updating the state from the pending state to the standby state, from the committed state to the probation state, or from the probation state to the standby state based on a determination that a confidence measure associated with the the filtered ROI does not exceed a second threshold.

In some examples, method further 1100 further comprises updating a state associated with the filtered ROI, where updating the state associated with the filtered ROI comprises updating the state from the pending state to the standby state, from the committed state to the probation state, or from the probation state to the standby state based on a determination that the filtered ROI does not overlap with a previous filtered ROI.

In some examples, the particular state of the finite state machine is a committed state.

In some examples, method 1100 further comprises applying a finite state machine to each of the filtered ROI, the primary ROI, and the secondary ROI, where applying the one or more auto-focus processes is based on a respective state of the finite state machine associated with each of the filtered ROI, the primary ROI, and the secondary ROI.

In some examples, method 1100 is carried out by an image capturing device including a camera and a control system configured to perform the steps of method 1100.

In such examples, the image capturing device is a mobile device, where the image frame is captured by the camera.

In some examples, a method may include receiving an image frame captured by an image capturing device. The method may also include determining a saliency heatmap representing saliency of pixels in the image frame. The method may further include determining, based on the saliency heatmap, a primary ROI. The method may additionally include determining a banned region surrounding the primary ROI. The method may also include determining, based on the saliency heatmap, a secondary ROI such that the secondary ROI does not overlap with the primary ROI and does not overlap with the banned region. The method may further include controlling one or more autofocus processes based on the primary ROI and the secondary ROI.

### III. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

1. A method comprising:
receiving an image frame captured by an image capturing device;
determining a saliency heatmap representing saliency of pixels in the image frame;
determining, based on the saliency heatmap, a primary region of interest (ROI) and a secondary ROI for the image frame;
determining a filtered ROI for the image frame, wherein the filtered ROI updates from a previous filtered ROI to the primary ROI based on a saliency difference between the previous filtered ROI and the primary ROI exceeding a first threshold; and
applying one or more auto-focus processes based on at least one of the filtered ROI, the primary ROI, or the secondary ROI.

2. The method of claim 1, wherein determining the primary ROI and the secondary ROI is based on the primary ROI having a greater average saliency than the secondary ROI.

3. The method of claim 1, wherein the filtered ROI updates from the previous filtered ROI to the primary ROI further based on an amount of overlap of the previous filtered ROI to the primary ROI not exceeding a second threshold.

4. The method of claim 1, wherein when the filtered ROI is set to the previous filtered ROI, the filtered ROI is associated with an updated average saliency value based on the saliency heatmap.

5. The method of claim 1, wherein determining, based on the saliency heatmap, the primary ROI and the secondary ROI comprises determining a plurality of candidate anchor boxes distributed over the saliency heatmap, wherein each of the candidate anchor boxes is associated with a saliency measure, wherein determining the primary ROI and the secondary ROI is based on the saliency measure of each of the candidate anchor boxes.

6. The method of claim 5, wherein the plurality of candidate anchor boxes comprises a plurality of anchor boxes with a plurality of differing aspect ratios at a given location in the image frame.

7. The method of claim 5, wherein the candidate anchor boxes are evenly distributed over the saliency heatmap.

8. The method of claim 5, wherein the plurality of candidate anchor boxes comprises a plurality of anchor boxes with a plurality of sizes at a given location in the image frame.

9. The method of claim 1, wherein the primary ROI is associated with a primary confidence measurement and the previous filtered ROI is associated with a filtered confidence measurement based on the saliency heatmap, wherein the saliency difference is based on the primary confidence measurement and the filtered confidence measurement.

10. The method of claim 9, wherein the primary confidence measurement is based on an average of one or more saliency values at one or more pixels within the primary ROI and the filtered confidence measurement is based on an average of one or more saliency values at one or more pixels within the previous filtered ROI.

11. The method of claim 1, wherein determining the primary ROI and the secondary ROI is based on the primary ROI being at least a threshold distance away from the secondary ROI.

12. The method of claim 1, wherein determining the primary ROI and the secondary ROI comprises:
determining a primary ROI based on the saliency heatmap;
determining a banned region around the primary ROI; and
based on the banned region around the primary ROI and the saliency heatmap, determining the secondary ROI such that the secondary ROI is not within the primary ROI or the banned region around the primary ROI.

13. The method of claim 1, wherein the previous filtered ROI is based on a previous image frame captured prior to the image frame.

14. The method of claim 1, wherein determining a saliency heatmap representing saliency of each pixel in the image frame comprises applying a pre-trained machine learning model to the image frame to determine the saliency heatmap.

15. The method of claim 1, wherein applying the one or more auto-focus processes comprises causing a camera lens to adjust focus to the filtered ROI.

16. The method of claim 1, wherein applying the one or more auto-focus process comprises applying a blur to a region of the image frame outside of the filtered ROI.

17. The method of claim 1, further comprising applying a finite state machine to the filtered ROI, wherein applying the one or more auto-focus processes is based on the filtered ROI being associated with a particular state of the finite state machine.

18. The method of claim 17, wherein the finite state machine comprises a committed state indicating that the filtered ROI is usable, a pending state indicating that the filtered ROI is waiting for stability verification, a probation state indicating that the filtered ROI is usable but waiting for failure of stability verification, and a standby state indicating that the filtered ROI is not usable.

19. (canceled)

20. (canceled)

21. (canceled)

22. (canceled)

23. An image capturing device comprising:
a camera; and
a control system is configured to:
receive an image frame captured by the image capturing device;
determine a saliency heatmap representing saliency of pixels in the image frame;
determine, based on the saliency heatmap, a primary region of interest (ROI) and a secondary ROI for the image frame;
determine a filtered ROI for the image frame, wherein the filtered ROI updates from a previous filtered ROI to the primary ROI based on a saliency difference between the previous filtered ROI and the primary ROI exceeding a first threshold; and
apply one or more auto-focus processes based on at least one of the filtered ROI, the primary ROI, or the secondary ROI.

24. (canceled)

25. A non-transitory computer readable storing program instructions executable by one or more processors to cause the one or more processors to perform operations comprising:
receiving an image frame captured by an image capturing device;
determining a saliency heatmap representing saliency of pixels in the image frame;
determining, based on the saliency heatmap, a primary region of interest (ROI) and a secondary ROI for the image frame;
determining a filtered ROI for the image frame, wherein the filtered ROI updates from a previous filtered ROI to the primary ROI based on a saliency difference between the previous filtered ROI and the primary ROI exceeding a first threshold; and
applying one or more auto-focus processes based on at least one of the filtered ROI, the primary ROI, or the secondary ROI.
